(19) United States
(12) Patent Application Publication
(10) Pub. No.: US 2022/0248332 A1
(43) Pub. Date: Aug. 4, 2022

(54) METHOD FOR ENTERING DORMANCY BEHAVIOR AND TERMINAL

(71) Applicant: VIVO MOBILE COMMUNICATION CO., LTD., Dongguan (CN)

(72) Inventors: Dongru LI, Dongguan (CN); Dajie JIANG, Dongguan (CN); Xueming PAN, Dongguan (CN); Wei BAO, Dongguan (CN)

(73) Assignee: VIVO MOBILE COMMUNICATION CO., LTD., Dongguan (CN)

(21) Appl. No.: 17/727,690

(22) Filed: Apr. 22, 2022

Related U.S. Application Data
(63) Continuation of application No. PCT/CN2020/128941, filed on Nov. 16, 2020.

(30) Foreign Application Priority Data
Nov. 21, 2019 (CN) 201911151656.2

(51) Int. Cl. H04W 52/02; H04L 1/18

(52) U.S. Cl. CPC H04W 52/0258; H04L 1/1883

(57) ABSTRACT

A method for entering a dormancy behavior and a terminal are provided. The method includes: receiving indication information indicating that the terminal enters the dormancy behavior; and in a case that conditions of validity are satisfied, entering, by the terminal, the dormancy behavior based on the indication information, where the conditions of validity include at least one of the following: scheduled data is successfully transmitted; a quantity of times of transmission of the scheduled data reaches a maximum quantity of times of retransmission; or a first timer expires.

### CROSS-REFERENCE TO RELATED APPLICATIONS

This application is a continuation of International Application No. PCT/CN2020/128941, filed Nov. 16, 2020, which claims priority to Chinese Patent Application No. 201911151656.2, filed Nov. 21, 2019. The entire contents of each of the above-referenced applications are expressly incorporated herein by reference.

### TECHNICAL FIELD

The present disclosure relates to the field of communications technologies, and in particular, to a method for entering a dormancy behavior and a terminal.

### BACKGROUND

Dormancy behavior is introduced in some communication systems, for example, defined as a dormant state in the LTE-Advanced (LTE-A) system, and defined as a dormant like behavior in the New Radio (NR) system.

The dormancy behavior of the terminal is mainly indicated by a network side whether the terminal enters the dormancy behavior. A current behavior of the terminal is that if a dormancy indication is received, the terminal immediately enters the dormancy behavior, resulting in poor transmission performance of the terminal.

### SUMMARY

Embodiments of the present disclosure provide a method for entering a dormancy behavior and a terminal, to solve the problem of poor transmission performance of the terminal.

According to a first aspect, an embodiment of the present disclosure provides a method for entering a dormancy behavior, where the method is applied to a terminal and includes:

receiving indication information indicating that the terminal enters the dormancy behavior; and

in a case that conditions of validity are satisfied, entering, by the terminal, the dormancy behavior based on the indication information, where the conditions of validity include at least one of the following:

scheduled data is successfully transmitted;

a quantity of times of transmission of the scheduled data reaches a maximum quantity of times of retransmission; or

a first timer expires.

According to a second aspect, an embodiment of the present disclosure provides a terminal, including:

a receiving module, configured to receive indication information indicating that the terminal enters a dormancy behavior; and

an entry module, configured to: in a case that conditions of validity are satisfied, assist the terminal enter the dormancy behavior based on the indication information, where the conditions of validity include at least one of the following:

scheduled data is successfully transmitted;

a quantity of times of transmission of the scheduled data reaches a maximum quantity of times of retransmission; or

a first timer expires.

According to a third aspect, an embodiment of the present disclosure provides a terminal, including a memory, a processor, and a program stored in the memory and executable on the processor, where when the program is executed by the processor, steps of the method for entering a dormancy behavior provided in the embodiments of the present disclosure are implemented.

According to a fourth aspect, an embodiment of the present disclosure provides a computer-readable storage medium, where the computer-readable storage medium stores a computer program, and when the computer program is executed by a processor, steps of the method for entering a dormancy behavior provided in the embodiments of the present disclosure are implemented.

In the embodiments of the present disclosure, through receiving indication information indicating that the terminal enters the dormancy behavior, in a case that conditions of validity are satisfied, the terminal enters the dormancy behavior based on the indication information, where the conditions of validity include at least one of the following: scheduled data is successfully transmitted; a quantity of times of transmission of the scheduled data reaches a maximum quantity of times of retransmission; or a first timer expires. In this way, the terminal enters the dormancy behavior only when the conditions of validity are satisfied, and the transmission performance of the terminal may be improved compared with entering the dormancy behavior immediately in the related art.

### BRIEF DESCRIPTION OF DRAWINGS

FIG. 1 is a structural diagram of a network system applicable to an embodiment of the present disclosure;

FIG. 2 is a schematic flowchart of a method for entering a dormancy behavior according to an embodiment of the present disclosure;

FIG. 3 is a structural diagram of a terminal according to an embodiment of the present disclosure; and

FIG. 4 is a structural diagram of another terminal according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

The term “include” and any other variants in the specification and claims of the present disclosure mean to cover the non-exclusive inclusion, for example, a process, method, system, product, or device that includes a list of steps or units is not necessarily limited to those steps or units, but may include other steps or units not expressly listed or inherent to such a process, method, product, or device. In addition, “and/or” used in the specification and the claims means at least one of the connected objects. For example, A and/or B represents the following three cases: Only A exists, only B exists, and both A and B exist.

In the embodiments of the present disclosure, the term such as “exemplary” or “for example” is used to represent an example, an instance, or a description. Any embodiment or design solution described as “exemplary” or “for example” in the embodiments of the present disclosure should not be construed as being more preferred or advantageous than other embodiments or design solutions. To be precise, the use of the term such as “exemplary” or “for example” is intended to present a related concept in a specific manner.

Embodiments of the present disclosure will be described below with reference to the accompanying drawings. The method for entering a dormancy behavior and a terminal provided in the embodiments of the present disclosure may be applied to a wireless communication system. The wireless communication system may be a New Radio (NR) system or other systems such as an LTE-Advanced (LTE-A) system, a Long Term Evolution (LTE) system, or a subsequent evolution communication system.

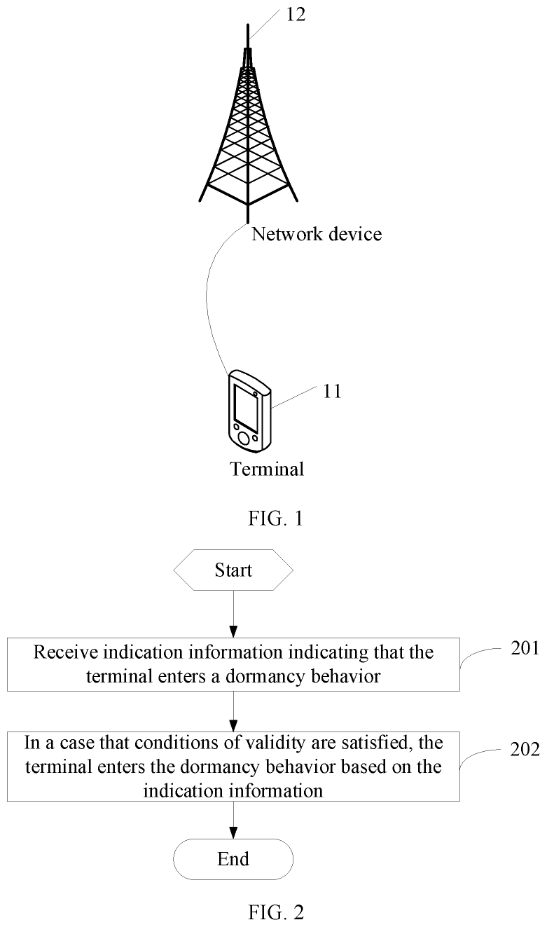

Referring to FIG. 1, FIG. 1 is a structural diagram of a network system applicable to an embodiment of the present disclosure. As shown in FIG. 1, the network system includes a terminal 11 and a network device 12, where the terminal 11 may be User Equipment (UE) or other terminal side devices such as a mobile phone, a tablet personal computer, a laptop computer, a Personal Digital Assistant (PDA), a Mobile Internet Device (MID), a wearable device, or a robot. It should be noted that a specific type of the terminal 11 is not limited in the embodiments of the present disclosure. The above-mentioned network device 12 may be a 4G base station, or a 5G base station, or a later version base station, or a base station in other communication systems, or called as a NodeB, an evolved NodeB, a Transmission Reception Point (TRP), an Access Point (AP), or other vocabularies in the field. As long as the same technical effect is achieved, the network device is not limited to a specific technical vocabulary. In addition, the network device 12 may be a Master Node (MN) or a Secondary Node (SN). It should be noted that in the embodiments of the present disclosure, only the 5G base station is used as an example, but a specific type of the network device is not limited.

Referring to FIG. 2, FIG. 2 is a flowchart of a method for entering a dormancy behavior according to an embodiment of the present disclosure. The method is applied to a terminal. As shown in FIG. 2, the method includes the following steps.

Step 201. Receive indication information indicating that the terminal enters a dormancy behavior.

The indication information may be sent by the network device, and the indication information may be a Physical Downlink Control Channel (PDCCH). The PDCCH may be DCI, for example, a DCI format 1-1 or a DCI format 0-1. Alternatively, the indication information may be other PDCCH messages. Alternatively, the indication information may be a Media Access Control Control Element (MAC CE), for example, steps of receiving indication information indicating that the terminal enters the dormancy behavior include:

receiving a first PDCCH or a MAC CE indicating that the terminal enters the dormancy behavior.

Further, the first PDCCH may be a PDCCH on which data is scheduled at the same time or a PDCCH on which no data is scheduled. In addition, in the NR system, the first PDCCH may be used to indicate that the terminal enters the dormancy behavior, while in the LTE and LTE-A systems, the MAC CE may be used to indicate that the terminal enters the dormancy behavior. Certainly, this is not limited.

In addition, the indication information may be a Scell dormancy indication, and the indication is used to indicate that the terminal enters a dormancy behavior or a non-dormancy behavior. In addition, in this embodiment of the present disclosure, conversion between the dormancy behavior and the non-dormancy behavior may be based on a Bandwidth Part (BWP) framework. Certainly, this is not limited. For example, the conversion may be based on a network side RRC, the MAC CE, or DCI signaling, or may be based on a non-bandwidth part.

In this embodiment of the present disclosure, the dormancy behavior may be a dormant state or a dormant like behavior.

In addition, if the terminal enters the dormancy behavior, the terminal ignores to monitor the PDCCH, or the terminal may monitor the PDCCH in a first period, where the first period is greater than a second period, and the second period is a monitoring period for monitoring the PDCCH when the terminal does not enter the dormancy behavior.

For example, when the terminal is in the dormancy behavior, based on network side configuration, the terminal ignores to monitor the PDCCH or the period of the terminal monitoring the PDCCH is long, for example, the PDCCH is monitored every 2,560 slots; and in addition, in the dormancy behavior, the network may configure whether the terminal performs partial measurement and/or partial reporting of Channel State Information (CSI), beam management, or the like. However, in the non-dormancy behavior, the terminal monitors the PDCCH frequently based on the network side configuration, for example, the PDCCH is monitored every downlink slot; and in the non-dormancy behavior, the terminal needs to perform CSI measurement and reporting, and in this behavior, power consumption of the terminal is relatively large.

Step 202. In a case that conditions of validity are satisfied, the terminal enters the dormancy behavior based on the indication information, where the conditions of validity include at least one of the following:

scheduled data is successfully transmitted;

a quantity of times of transmission of the scheduled data reaches a maximum quantity of times of retransmission; or

a first timer expires.

The scheduled data may be downlink data and/or uplink data scheduled before or when the indication information is received, and successful transmission of the scheduled data may mean that the terminal successfully receives the scheduled downlink data and/or the terminal successfully sends the scheduled uplink data.

In some embodiments, the scheduled data may be data scheduled by the first PDCCH, or the scheduled data may be data scheduled before the first PDCCH is received, for example, the scheduled data is data scheduled by the second PDCCH, where a reception time of the second PDCCH is before a reception time of the first PDCCH.

It may be achieved by the successful transmission of the scheduled data that in a case of receiving the indication information indicating that the terminal enters the dormancy behavior, if the scheduled data is successfully transmitted, the terminal enters the dormancy behavior. This may improve the transmission performance of the terminal.

However, that the transmission of the scheduled data reaches the maximum quantity of times of retransmission may be that the quantity of times of retransmission of the scheduled data reaches the maximum quantity of times of retransmission, so that the terminal enters the dormancy behavior. For example, the scheduled data is downlink data and reaches the maximum quantity of times of retransmission, and the terminal enters the dormancy behavior no matter the scheduled data is successfully received or not. This may improve the transmission performance of the terminal.

The first timer may be a timer that is started after the indication information is received. Through the first timer, the terminal may be prevented from going into the dormancy behavior immediately, so as to improve the transmission performance of the terminal.

It should be noted that, in this embodiment of the present disclosure, the timer and the maximum quantity of times of retransmission may be configured by the network side to the terminal, or pre-configured by the terminal, or agreed in a protocol, or the like.

In this embodiment of the present disclosure, through the foregoing steps, it may be implemented that the terminal enters the dormancy behavior based on the indication information only in a case that the conditions of validity are satisfied, that is, the indication information takes effect only in this case. This may avoid data transmission delay and transmission performance degradation caused by the terminal entering the dormancy behavior immediately after receiving the indication information when there is still scheduled data that has not been transmitted or received successfully.

As an optional implementation, if the scheduled data is downlink data, successful transmission of the scheduled data means that the terminal successfully receives the scheduled data, or a sent Hybrid Automatic Repeat Request (HARQ) feedback corresponding to the scheduled data is an acknowledgement (ACK).

In this embodiment, if the downlink data is successfully received, or the sent HARQ feedback corresponding to the scheduled data is ACK, the terminal enters the dormancy behavior, so as to improve the transmission performance of the terminal. For example, regardless of whether the network side configures the maximum quantity of times of retransmission and the first timer for the terminal, as long as the terminal successfully receives the scheduled PDSCH or after the terminal sends an ACK corresponding to the PDSCH to the network side, the terminal enters the dormancy behavior.

As an optional implementation, if the network side does not configure the maximum quantity of times of retransmission and the first timer for the terminal, after the terminal receives the indication information, if the terminal fails to receive the scheduled PDSCH, or after the terminal sends a Negative-Acknowledgment (NACK) corresponding to the PDSCH to the network side, the terminal may also enter the dormancy behavior.

As an optional implementation, if the network side does not configure the maximum quantity of times of retransmission and the first timer for the terminal, the terminal directly enters the dormancy behavior after receiving the indication information.

As an optional implementation, if the scheduled data is uplink data, the successful transmission of the scheduled data means that the terminal does not receive an indication of rescheduling the scheduled data.

The indication of rescheduling the scheduled data may be rescheduling a PDCCH of the data.

No indication received to reschedule the scheduled data may be that the terminal does not receive an indication of rescheduling the data within a preset time after receiving the indication information.

In this implementation, for the uplink data, if no indication of rescheduling the scheduled data is received, it may be determined that the uplink data is transmitted successfully. The indication may be retransmission PDCCH for scheduling the data, for example, retransmission of the first PDCCH, certainly, may also be a PDCCH newly sent by the network device for rescheduling the data, which is not limited.

In this implementation, it may be implemented that the uplink data is transmitted successfully, and the terminal enters the dormancy behavior, so as to improve the transmission performance of the terminal. For example, regardless of whether the network side configures the maximum quantity of times of retransmission and the first timer for the terminal, the terminal enters the dormancy behavior when not receiving an indication of rescheduling the scheduled data (namely, it is proved that the network device has successfully demodulated the Physical Uplink Shared Channel (PUSCH).

As an optional implementation, if the network side does not configure the maximum quantity of times of retransmission and the first timer for the terminal, the terminal enters the dormancy behavior when receiving an indication of rescheduling the scheduled data (it is proved that the network device still fails to demodulate the PUSCH).

As an optional implementation, if the network side does not configure the maximum quantity of times of retransmission and the first timer for the terminal, after PUSCH retransmission, the terminal enters the dormancy behavior when receiving an indication of rescheduling the scheduled data (it is proved that the network device still fails to demodulate the PUSCH).

As an optional implementation, if the scheduled data is downlink data, the first timer is started when the HARQ feedback that is sent by the terminal and that is corresponding to the scheduled data is NACK, or if the scheduled data is uplink data, the first timer is started when the terminal has sent the scheduled data.

That the first timer is started in a case that the sent HARQ feedback corresponding to the scheduled data is NACK may be that the terminal starts the first timer after sending the HARQ feedback of the NACK corresponding to the data. For example, the first timer is started within one symbol after the terminal sends the HARQ feedback of the NACK corresponding to the data. It should be noted that, if a retransmission mechanism is adopted for transmission of the data, the first timer may be corresponding to the current quantity of times of retransmission, or may be a first timer that the terminal may start every time after sending the HARQ feedback of the NACK corresponding to the data.

That the first timer is started in a case that the terminal has sent the scheduled data may be that the first timer is started after the terminal has sent the scheduled data, for example, the first timer is started within one symbol after the terminal has sent the scheduled data. It should be noted that, if a retransmission mechanism is adopted for transmission of the data, the first timer may be corresponding to the current quantity of times of retransmission, or the terminal may start the corresponding first timer every time after sending the scheduled data.

In this implementation, it may be implemented that the terminal enters the dormancy behavior only after data transmission is performed between the terminal and the network device, and the data transmission is equal to the corresponding duration of the first timer, so as to increase a transmission opportunity of the terminal.

As an optional implementation, in a case that the terminal is configured with a first timer, the conditions of validity include:

before the first timer expires, the scheduled data is transmitted successfully.

If the scheduled data is downlink data, that the scheduled data is transmitted successfully before the first timer expires may be that the terminal successfully receives the scheduled data before the first timer expires, or the sent HARQ feedback corresponding to the scheduled data is the ACK. For example, the network side configures the first timer for the terminal, but does not configure the maximum quantity of times of retransmission. For the downlink data, if the terminal successfully receives the scheduled PDSCH within the first timer or the terminal sends the ACK corresponding to the PDSCH to the network side, the terminal enters the dormancy behavior; and for the uplink data, if the terminal does not receive the retransmission PDCCH for rescheduling the scheduled data within the first timer (namely, it is proved that the network device has successfully demodulated the PUSCH), the terminal enters the dormancy behavior.

In this implementation, it may be implemented that if the scheduled data is transmitted successfully, the terminal enters the dormancy behavior, so as to save power consumption of the terminal.

It should be noted that, in a case that the first timer is configured, the conditions of validity may also be that the first timer expires, that is, as long as the first timer expires, the terminal enters the dormancy behavior, that is, regardless of whether the data transmission is successful or not, as long as the first timer expires, the terminal enters the dormancy behavior.

For example, after the first timer expires, the terminal still fails to receive the scheduled PDSCH or the NACK that is sent by the terminal to the network side and that is corresponding to the PDSCH, and the terminal enters the dormancy behavior (namely, the indication information takes effect); or after the terminal receives the retransmission PDCCH that reschedules the scheduled data before the first timer expires (namely, it is proved that the network device still fails to demodulate the PUSCH), the first timer continues to run, and after the first timer expires, the terminal enters the dormancy behavior.

For another example, in a case that the network side configures the terminal with the maximum quantity of times of retransmission and the first timer: when the transmission of the scheduled data reaches the maximum quantity of times of retransmission, after the first timer expires, and when the terminal still fails to receive the scheduled PDSCH or after the terminal sends the NACK corresponding to the PDSCH to the network side, the terminal enters the dormancy behavior.

As an optional implementation, in a case that the terminal is configured with the maximum quantity of times of retransmission, the conditions of validity include:

when the quantity of times of transmission of the scheduled data is less than or equal to the maximum quantity of times of retransmission, the scheduled data is transmitted successfully.

That when the quantity of times of transmission of the scheduled data is less than or equal to the maximum quantity of times of retransmission, the scheduled data is transmitted successfully may be that when the maximum quantity of times of retransmission is not exceeded, as long as the scheduled data is transmitted successfully, the terminal enters the dormancy behavior. For example, in a case that the network side configures the terminal with the maximum quantity of times of retransmission but does not configure the first timer: when the quantity of times of transmission of the scheduled data is less than or equal to the maximum quantity of times of retransmission, if the terminal does not receive the PDCCH that reschedules the scheduled data (namely, it is proved that the network device has successfully demodulated the PUSCH), the terminal enters the dormancy behavior; or when the quantity of times of transmission of the scheduled data is less than or equal to the maximum quantity of times of retransmission, if the terminal successfully receives the scheduled PDSCH, or the terminal sends the ACK corresponding to the PDSCH to the network side, the terminal enters the dormancy behavior.

In addition, in this embodiment of the present disclosure, if the quantity of times of transmission of the scheduled data reaches the maximum quantity of times of retransmission, the terminal enters the dormancy behavior, that is, as long as the quantity of times of transmission of the scheduled data reaches the maximum quantity of times of retransmission, the terminal enters the dormancy behavior. For example, in a case that the network side configures the terminal with the maximum quantity of times of retransmission but does not configure the first timer: when the quantity of times of transmission of the scheduled data reaches the maximum quantity of times of retransmission, if the terminal still receives the PDCCH that reschedules the scheduled data (namely, it is proved that the network device still fails to successfully demodulate the PUSCH during the maximum quantity of times of retransmission), the terminal enters the dormancy behavior; or when the quantity of times of transmission of the scheduled data reaches the maximum quantity of times of retransmission, if the terminal still fails to successfully receive the scheduled PDSCH, or the terminal sends the NACK corresponding to the PDSCH to the network side, the terminal enters the dormancy behavior. For another example, when the network side configures the terminal with the maximum quantity of times of retransmission and the first timer: when the quantity of times of transmission of the scheduled data reaches the maximum quantity of times of retransmission, if the terminal still receives the PDCCH that reschedules the scheduled data within the first timer (namely, it is proved that the network device still fails to successfully demodulate the PUSCH during the maximum quantity of times of retransmission), the terminal enters the dormancy behavior.

As an implementation, in a case that the terminal is configured with a first timer and the maximum quantity of times of retransmission, the conditions of validity include:

the quantity of times of transmission of the scheduled data is less than or equal to the maximum quantity of times of retransmission, and before the first timer expires, the scheduled data is transmitted successfully.

In this implementation, in a case that the quantity of times of transmission of the scheduled data is less than or equal to the maximum quantity of times of retransmission, before the first timer expires, if the scheduled data is transmitted successfully, the terminal enters the dormancy behavior. For example, in a case that the network side configures the terminal with the maximum quantity of times of retransmission and the first timer: when the quantity of times of transmission of the scheduled data is less than or equal to the maximum quantity of times of retransmission, if the terminal does not receive the PDCCH that reschedules the scheduled data within the first timer (namely, it is proved that the network device has successfully demodulated the PUSCH), the terminal enters the dormancy behavior; or when the quantity of times of transmission of the scheduled data is less than or equal to the maximum quantity of times of retransmission, after the terminal successfully receives the scheduled PDSCH within the first timer, or the terminal sends the ACK corresponding to the PDSCH to the network side, the terminal enters the dormancy behavior.

As an implementation, the first timer is a Discontinuous Reception (DRX) retransmission timer, or the first timer may also be a timer newly defined in this embodiment of the present disclosure, for example, the first timer is a dormancy-retransmission timer.

The dormancy-retransmission timer may be a timer used to indicate a maximum quantity of PDCCH time domain resources (for example, a slot and a symbol) that the terminal needs to continuously monitor in order to receive expected downlink retransmission data.

For example, the dormancy-retransmission timer is a downlink retransmission timer. For example, after the quantity of times of transmission of the scheduled data reaches the maximum quantity of times of retransmission, and a downlink retransmission timer of the maximum quantity of times of retransmission expires, if the terminal still fails to successfully receive the scheduled PDSCH or the terminal sends the NACK corresponding to the PDSCH to the network side, the terminal enters the dormancy behavior; alternatively, when the quantity of times of transmission of the scheduled data is less than or equal to the maximum quantity of times of retransmission, and during running of the downlink retransmission timer of current transmission, after the terminal successfully receives the scheduled PDSCH or the terminal sends the ACK corresponding to the PDSCH to the network side, the terminal enters the dormancy behavior.

For another example, the dormancy-retransmission timer is an uplink retransmission timer. When the quantity of times of transmission of the scheduled data is less than or equal to the maximum quantity of times of retransmission, after an uplink retransmission timer of current transmission expires, if the terminal does not receive a PDCCH that reschedules the scheduled data (namely, it is proved that the network device has successfully demodulated the PUSCH), the terminal enters the dormancy behavior; or when the quantity of times of transmission of the scheduled data reaches the maximum quantity of times of retransmission, if the PDCCH that reschedules the scheduled data is still received within the uplink retransmission timer (namely, it is proved that the network device still fails to successfully demodulate the PUSCH during the maximum quantity of times of retransmission), the terminal enters the dormancy behavior.

In some embodiments, the terminal is configured with a second timer;

in a case that the scheduled data is downlink data, the first timer is started when the HARQ feedback that is sent by the terminal and that is corresponding to the scheduled data is NACK, and the second timer expires, where the second timer is started in a case that the terminal has sent the HARQ feedback; or

in a case that the scheduled data is uplink data, the first timer is started in a case that the second timer expires, where the second timer is started in a case that the terminal has sent the scheduled data.

The first timer may be a DRX retransmission timer or a dormancy-retransmission timer, and the second timer may be a timer representing a minimum time interval to wait for retransmission. In some embodiments, the second timer is a DRX HARQ timer, or the second timer is a dormancy HARQ timer, for example, a drx-HARQ-RTT-Timer or a dormancy-HARQ-RTT-Timer.

That the first timer is started when the HARQ feedback that is sent by the terminal and that is corresponding to the scheduled data is NACK, and the second timer expires may be that the first timer is started when the HARQ feedback that is sent by the terminal and that is corresponding to the scheduled data is NACK, and after the second timer expires. For example, the first timer is started at a first symbol when the HARQ feedback sent by the terminal is NACK, and after the second timer expires.

It should be noted that, in this embodiment, the first timer may be to stop the first timer when a PDCCH indicating uplink and downlink retransmission is received. Certainly, this is not limited. For example, the first timer may also be stopped when the scheduled data is successfully transmitted.

For downlink transmission, that the second timer is started in a case that the terminal has sent the HARQ feedback may be that the second timer is started after the terminal has sent the HARQ feedback, and the second timer is started regardless of ACK or NACK. For example, the second timer is started at a first symbol after having sent the ACK/NACK.

The first timer is started when the HARQ feedback that is sent by the terminal and that is corresponding to the scheduled data is NACK, and the second timer expires. For example, the first timer is started at a first symbol when the HARQ feedback is NACK and the second timer expires.

For uplink transmission, that the second timer is started in a case that the terminal has sent the scheduled data may be that the second timer is started after the terminal has sent the scheduled data. For example, the second timer is started at a first symbol after having sent the scheduled data.

That the first timer is started in a case that the second timer expires may be that the first timer is started after the second timer expires. For example, the first timer is started at a first symbol after the second timer expires.

That the terminal ignore to monitor a PDCCH before the second timer expires may be that the terminal monitors the PDCCH after the second timer expires.

In this embodiment, a better power saving effect may be achieved through the first timer and the second timer.

In some embodiments, the terminal ignores to monitor the PDCCH before the second timer expires, which may further save power consumption of the terminal.

In some embodiments, the terminal is configured with the first timer and the second timer for each HARQ process respectively.

The configuring with the corresponding first timer and the second timer for each HARQ process respectively may be that each HARQ process is configured with a corresponding first timer and a second timer.

In this implementation, it may be implemented that the first timer and the second timer are configured based on the HARQ process, for example, the first timer and the second timer are configured in the manner of each HARQ Process parameter. Therefore, the corresponding behavior is implemented in the unit of HARQ, so that the terminal is more power-saving.

In the embodiments of the present disclosure, through receiving indication information indicating that the terminal enters the dormancy behavior, in a case that conditions of validity are satisfied, the terminal enters the dormancy behavior based on the indication information, where the conditions of validity include at least one of the following: scheduled data is successfully transmitted; a quantity of times of transmission of the scheduled data reaches a maximum quantity of times of retransmission; or a first timer expires. In this way, the terminal enters the dormancy behavior only when the conditions of validity are satisfied, and the transmission performance of the terminal may be improved compared with entering the dormancy behavior immediately in the related art.

It should be noted that, in another embodiment of the present disclosure, a method for entering a dormancy behavior may also be provided. For example, the terminal receives the indication information and immediately enters the dormancy behavior, where the terminal still monitors a retransmission related PDCCH during the dormancy behavior. For the indication information, refer to relevant descriptions above. Details are not described herein again.

The method for entering a dormancy behavior provided in this embodiment of the present disclosure is illustrated below with a plurality of embodiments:

### Embodiment 1

In this embodiment, the network side configures a Primary Cell (PCell)/Primary Secondary Cell (PSCell) with a connected DRX (CDRX) mechanism, then within an active time, the terminal may enter a time delay of the dormancy behavior by receiving the indication information and based on the conditions of validity. Specific embodiments are as follows.

In one solution: after the terminal receives the indication information indicating that the terminal enters the dormancy behavior, the terminal needs to meet one of the following conditions during downlink to enter the dormancy behavior:

1. When the quantity of times of transmission of the scheduled data reaches the maximum quantity of times of retransmission, after the first timer of the maximum quantity of times of retransmission expires, and when the terminal still fails to receive the scheduled PDSCH or the terminal sends the NACK corresponding to the PDSCH to the network side, the terminal enters the dormancy behavior;

2. When the quantity of times of transmission of the scheduled data is less than or equal to the maximum quantity of times of retransmission, and before the first timer expires, after the terminal successfully receives the scheduled PDSCH or after the terminal sends the ACK corresponding to the PDSCH to the network side, the terminal enters the dormancy behavior.

The terminal needs to meet one of the following conditions during uplink to enter the dormancy behavior:

1. When the quantity of times of transmission of the scheduled data is less than or equal to the maximum quantity of times of retransmission, when the terminal does not receive an indication of rescheduling the scheduled data after the first timer expires (namely, it is proved that the network device has successfully demodulated the PUSCH), the terminal enters the dormancy behavior;

2. When the quantity of times of transmission of the scheduled data reaches the maximum quantity of times of retransmission, if the terminal still receives the indication of rescheduling the scheduled data within the first timer (namely, it is proved that the network device still fails to successfully demodulate the PUSCH during the maximum quantity of times of retransmission), the terminal enters the dormancy behavior.

In this embodiment, the first timer may be a DRX retransmission timer, or may also be a dormancy-retransmission timer.

### Embodiment 2

The network side does not configure the PCell/PSCell with the CDRX mechanism, and the terminal may enter the time delay of the dormancy behavior by receiving the indication information and based on the conditions of validity. Specific embodiments are as follows.

In one solution: after the terminal receives the indication information indicating that the terminal enters the dormancy behavior, the terminal needs to meet one of the following conditions during downlink to enter the dormancy behavior:

1. When the quantity of times of transmission of the scheduled data reaches the maximum quantity of times of retransmission, after the first timer of the maximum quantity of times of retransmission expires, and when UE still fails to receive the scheduled PDSCH or after the terminal sends the NACK corresponding to the PDSCH to the network side, the terminal enters the dormancy behavior;

2. When the quantity of times of transmission of the scheduled data is less than or equal to the maximum quantity of times of retransmission, and before the first timer expires, after the terminal successfully receives the scheduled PDSCH or after the terminal sends the ACK corresponding to the PDSCH to the network side, the terminal enters the dormancy behavior.

The terminal needs to meet one of the following conditions during uplink to enter the dormancy behavior:

1. When the quantity of times of transmission of the scheduled data is less than or equal to the maximum quantity of times of retransmission, when the terminal does not receive an indication of rescheduling the scheduled data after the first timer expires (namely, it is proved that the network device has successfully demodulated the PUSCH), the terminal enters the dormancy behavior;

2. When the quantity of times of transmission of the scheduled data is in the maximum quantity of times of retransmission, if the terminal still receives the indication of rescheduling the scheduled data within the first timer (namely, it is proved that the network device still fails to successfully demodulate the PUSCH during the maximum quantity of times of retransmission), the terminal enters the dormancy behavior.

In this embodiment, the first timer may be a dormancy-retransmission timer.

### Embodiment 3

Regardless of whether the network side configures the PCell/PSCell with the CDRX mechanism, after receiving the indication information indicating that the terminal enters the dormancy behavior, the terminal immediately enters the dormancy behavior, where the terminal still monitors a retransmission related PDCCH during the dormancy behavior.

Referring to FIG. 3, FIG. 3 is a structural diagram of a terminal according to an embodiment of the present disclosure. As shown in FIG. 3, a terminal 300 includes:

a receiving module 301, configured to receive indication information indicating that the terminal enters a dormancy behavior; and

an entry module 302, configured to: in a case that conditions of validity are satisfied, assist the terminal enter the dormancy behavior based on the indication information, where the conditions of validity include at least one of the following:

scheduled data is successfully transmitted;

a quantity of times of transmission of the scheduled data reaches a maximum quantity of times of retransmission; or

a first timer expires.

In some embodiments, if the scheduled data is downlink data, successful transmission of the scheduled data means that the terminal successfully receives the scheduled data, or a sent hybrid automatic repeat request (HARQ) feedback corresponding to the scheduled data is an acknowledgement (ACK); or

if the scheduled data is uplink data, the successful transmission of the scheduled data means that the terminal does not receive an indication of rescheduling the scheduled data.

In some embodiments, if the scheduled data is downlink data, the first timer is started when the HARQ feedback that is sent by the terminal and that is corresponding to the scheduled data is NACK, or if the scheduled data is uplink data, the first timer is started when the terminal has sent the scheduled data.

In some embodiments, in a case that the terminal is configured with a first timer, the conditions of validity include:

before the first timer expires, the scheduled data is transmitted successfully.

In some embodiments, in a case that the terminal is configured with the maximum quantity of times of retransmission, the conditions of validity include:

when the quantity of times of transmission of the scheduled data is less than or equal to the maximum quantity of times of retransmission, the scheduled data is transmitted successfully.

In some embodiments, in a case that the terminal is configured with a first timer and the maximum quantity of times of retransmission, the conditions of validity include:

the quantity of times of transmission of the scheduled data is less than or equal to the maximum quantity of times of retransmission, and before the first timer expires, the scheduled data is transmitted successfully.

In some embodiments, the first timer is a discontinuous reception DRX retransmission timer, or the first timer is a dormancy-retransmission timer.

In some embodiments, the terminal is configured with a second timer;

in a case that the scheduled data is downlink data, the first timer is started when the HARQ feedback that is sent by the terminal and that is corresponding to the scheduled data is NACK, and the second timer expires, where the second timer is started in a case that the terminal has sent the HARQ feedback; or

in a case that the scheduled data is uplink data, the first timer is started in a case that the second timer expires, where the second timer is started in a case that the terminal has sent the scheduled data.

In some embodiments, the second timer is a DRXHARQ timer, or the second timer is a dormancy HARQ timer.

In some embodiments, the terminal ignore to monitor a PDCCH before the second timer expires.

In some embodiments, the terminal is configured with the first timer and the second timer for each HARQ process respectively.

In some embodiments, the receiving indication information indicating that the terminal enters the dormancy behavior include:

receiving a first PDCCH or a MAC CE indicating that the terminal enters the dormancy behavior.

In some embodiments, the scheduled data is data scheduled by the first PDCCH, or the scheduled data is data scheduled by a second PDCCH, where a reception time of the second PDCCH is before a reception time of the first PDCCH.

In some embodiments, if the terminal enters the dormancy behavior, the terminal ignores to monitor the PDCCH, or the terminal monitors the PDCCH in a first period, where the first period is greater than a second period, and the second period is a monitoring period for monitoring the PDCCH when the terminal does not enter the dormancy behavior.

The terminal provided in the embodiments of the present disclosure can implement the processes implemented by the terminal in the method embodiment in FIG. 2. To avoid repetition, details are not described herein again, and transmission performance of the terminal may be improved.

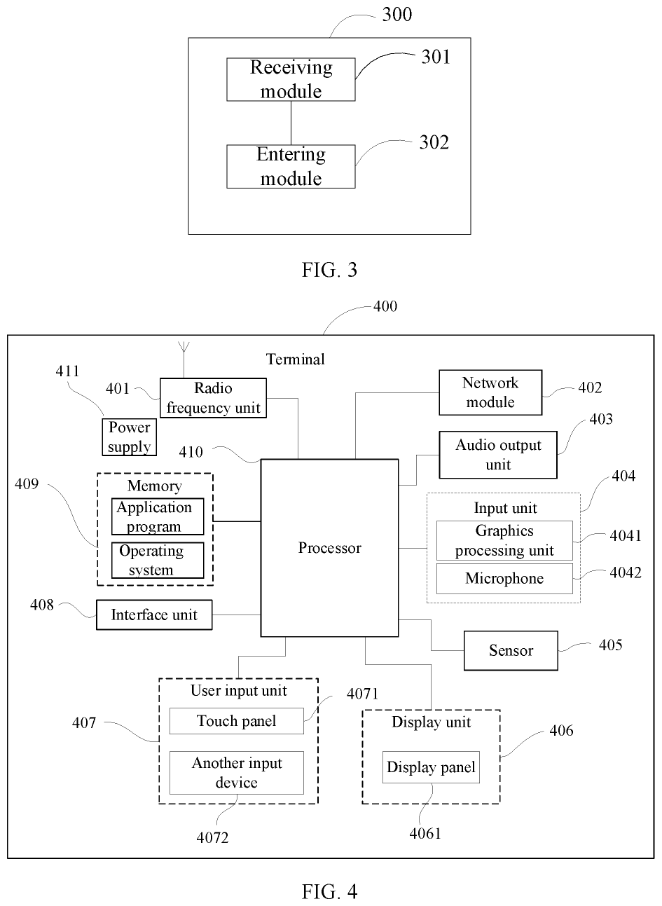

FIG. 4 is a schematic diagram of a hardware structure of a terminal according to an embodiment of the present disclosure.

The terminal 400 includes but is not limited to components such as a radio frequency unit 401, a network module 402, an audio output unit 403, an input unit 404, a sensor 405, a display unit 406, a user input unit 407, an interface unit 408, a memory 409, a processor 410, and a power supply 411. A person skilled in the art may understand that a structure of the terminal shown in FIG. 4 does not constitute a limitation to the terminal, and the terminal may include more or fewer components than those shown in the figure, or combine some components, or have different component arrangements. In this embodiment of the present disclosure, the terminal includes but is not limited to a mobile phone, a tablet computer, a laptop computer, a palmtop computer, an in-vehicle terminal, a robot, a wearable device, a pedometer, and the like.

The radio frequency unit 401 is configured to receive indication information indicating that the terminal enters a dormancy behavior; and

the processor 410 or the radio frequency unit 401 is configured to: in a case that conditions of validity are satisfied, assist the terminal enter the dormancy behavior based on the indication information, where the conditions of validity include at least one of the following:

scheduled data is successfully transmitted;

a quantity of times of transmission of the scheduled data reaches a maximum quantity of times of retransmission; or

a first timer expires.

In some embodiments, if the scheduled data is downlink data, successful transmission of the scheduled data means that the terminal successfully receives the scheduled data, or a sent hybrid automatic repeat request HARQ feedback corresponding to the scheduled data is an acknowledgement ACK; or

if the scheduled data is uplink data, the successful transmission of the scheduled data means that the terminal does not receive an indication of rescheduling the scheduled data.

In some embodiments, if the scheduled data is downlink data, the first timer is started when the HARQ feedback that is sent by the terminal and that is corresponding to the scheduled data is NACK, or if the scheduled data is uplink data, the first timer is started when the terminal has sent the scheduled data.

In some embodiments, in a case that the terminal is configured with a first timer, the conditions of validity include:

before the first timer expires, the scheduled data is transmitted successfully.

In some embodiments, in a case that the terminal is configured with the maximum quantity of times of retransmission, the conditions of validity include:

when the quantity of times of transmission of the scheduled data is less than or equal to the maximum quantity of times of retransmission, the scheduled data is transmitted successfully.

In some embodiments, in a case that the terminal is configured with a first timer and the maximum quantity of times of retransmission, the conditions of validity include:

the quantity of times of transmission of the scheduled data is less than or equal to the maximum quantity of times of retransmission, and before the first timer expires, the scheduled data is transmitted successfully.

In some embodiments, the first timer is a discontinuous reception DRX retransmission timer, or the first timer is a dormancy-retransmission timer.

In some embodiments, the terminal is configured with a second timer;

in a case that the scheduled data is downlink data, the first timer is started when the HARQ feedback that is sent by the terminal and that is corresponding to the scheduled data is NACK, and the second timer expires, where the second timer is started in a case that the terminal has sent the HARQ feedback; or

in a case that the scheduled data is uplink data, the first timer is started in a case that the second timer expires, where the second timer is started in a case that the terminal has sent the scheduled data.

In some embodiments, the second timer is a DRXHARQ timer, or the second timer is a dormancy HARQ timer.

In some embodiments, the terminal ignores to monitor a PDCCH before the second timer expires.

In some embodiments, the terminal is configured with the first timer and the second timer for each HARQ process respectively.

In some embodiments, the receiving indication information indicating that the terminal enters the dormancy behavior include:

receiving a first PDCCH or a MAC CE indicating that the terminal enters the dormancy behavior.

In some embodiments, the scheduled data is data scheduled by the first PDCCH, or the scheduled data is data scheduled by a second PDCCH, where a reception time of the second PDCCH is before a reception time of the first PDCCH.

In some embodiments, if the terminal enters the dormancy behavior, the terminal ignores to monitor the PDCCH, or the terminal monitors the PDCCH in a first period, where the first period is greater than a second period, and the second period is a monitoring period for monitoring the PDCCH when the terminal does not enter the dormancy behavior.

The terminal may improve the energy-saving effect of the terminal.

It should be understood that in this embodiment of the present disclosure, the radio frequency unit 401 may be configured to receive and transmit information, or receive and transmit signals during a call. Specifically, the radio frequency unit receives downlink data from a base station, and transmits the downlink data to the processor 410 for processing; and transmits uplink data to the base station. Generally, the radio frequency unit 401 includes, but is not limited to, an antenna, at least one amplifier, a transceiver, a coupler, a low noise amplifier, a duplexer, or the like. In addition, the radio frequency unit 401 may further communicate with another device by using a wireless communication system and network.

The terminal provides wireless broadband Internet access for a user through the network module 402, for example, assists the user to receive and send e-mails, browse web pages, access streaming media, or the like.

The audio output unit 403 may convert audio data received by the radio frequency unit 401 or the network module 402 or stored in the memory 409 into an audio signal, and output the audio signal into sound. In addition, the audio output unit 403 may further provide an audio output (for example, a call signal received voice, or a message received voice) related to a specific function implemented by the terminal 400. The audio output unit 403 includes a loudspeaker, a buzzer, a receiver, or the like.

The input unit 404 is configured to receive an audio signal or a video signal. The input unit 404 may include a graphics processing unit (GPU) 4041 and a microphone 4042. The graphics processing unit 4041 processes image data of a static image or a video obtained by an image capturing apparatus (for example, a camera) in a video capturing mode or an image capturing mode. A processed image frame may be displayed on the display unit 406. The image frame processed by the graphics processing unit 4041 may be stored in the memory 409 (or another storage medium) or sent via the radio frequency unit 401 or the network module 402. The microphone 4042 may receive a sound and can process such a sound into audio data. The processed audio data may be converted, in a call mode, into a format that may be sent to a mobile communication base station by using the radio frequency unit 401 for output.

The terminal 400 further includes at least one sensor 405, for example, a light sensor, a motion sensor, or another sensor. Specifically, the light sensor includes an ambient light sensor and a proximity sensor. The ambient light sensor may adjust luminance of the display panel 4061 based on the brightness of ambient light. The proximity sensor may turn off the display panel 4061 and/or backlight when the terminal 400 is moved to an ear. As a type of motion sensor, an accelerometer sensor may detect an acceleration value in each direction (generally, three axes), and detect a value and a direction of gravity when the accelerometer sensor is static, and may be configured to recognize a terminal posture (for example, screen switching between landscape and portrait modes, a related game, or magnetometer posture calibration), and perform a function related to vibration recognition (for example, a pedometer or a knock), and the like. The sensor 405 may further include a fingerprint sensor, a pressure sensor, an iris sensor, a molecular sensor, a gyroscope, a barometer, a hygrometer, a thermometer, an infrared sensor, and the like. Details are not described herein again.

The display unit 406 is configured to display information entered by a user or information provided for a user. The display unit 406 may include a display panel 4061, and the display panel 4061 may be configured in a form of liquid crystal display (LCD), organic light-emitting diode (OLED), or the like.

The user input unit 407 may be configured to receive input digit or character information and generate key signal input related to user setting and function control of the terminal. Specifically, the user input unit 407 includes a touch panel 4071 and another input device 4072. The touch panel 4071 is also referred to as a touchscreen, and may collect a touch operation performed by the user on or near the touch panel 4071 (for example, an operation performed on or near the touch panel 4071 by the user by using any appropriate object or accessory such as a finger or a stylus). The touch panel 4071 may include two parts: a touch detection apparatus and a touch controller. The touch detection apparatus detects a touch position of a user, detects a signal brought by a touch operation, and transmits the signal to the touch controller. The touch controller receives touch information from the touch detection apparatus, converts the touch information into contact coordinates, sends the contact coordinates to the processor 410, and receives and executes a command from the processor 410. In addition, the touch panel 4071 may be implemented by various types, such as a resistive type, a capacitive type, an infrared type, a surface acoustic wave type, or the like. In addition to the touch panel 4071, the user input unit 407 may further include another input device 4072. Specifically, the another input device 4072 may include but is not limited to a physical keyboard, function keys (for example, a volume control key and an on/off key), a trackball, a mouse, and a joystick. Details are not described herein again.

Further, the touch panel 4071 may cover the display panel 4061. When detecting a touch operation on or near the touch panel 4071, the touch panel 4071 transmits the touch operation to the processor 410 to determine a type of a touch event. Then, the processor 410 provides corresponding visual output on the display panel 4061 based on the type of the touch event. Although in FIG. 4, the touch panel 4071 and the display panel 4061 are used as two independent components to implement input and output functions of the terminal, in some embodiments, the touch panel 4071 and the display panel 4061 may be integrated to implement the input and output functions of the terminal. This is not specifically limited herein.

The interface unit 408 is an interface connecting an external apparatus to the terminal 400. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, a headset port, and the like. The interface unit 408 may be configured to receive input (for example, data information and power) from the external apparatus and transmit the received input to one or more elements in the terminal 400, or may be configured to transmit data between the terminal 400 and the external apparatus.

The memory 409 may be configured to store software programs and various data. The memory 409 may mainly include a program storage area and a data storage area. The program storage area may store an operating system, an application required by at least one function (for example, a sound play function or an image display function), or the like. The data storage area may store data (for example, audio data or an address book) or the like created based on use of the mobile phone. In addition, the memory 409 may include a high-speed random access memory, and may further include a non-volatile memory such as at least one magnetic disk storage device, a flash memory device, or another volatile solid-state storage device.

The processor 410 is a control center of the terminal, and connects all parts of the entire terminal by using various interfaces and lines. By running or executing a software program and/or a module stored in the memory 409 and invoking data stored in the memory 409, the processor 410 performs various functions of the terminal and data processing, to perform overall monitoring on the terminal. The processor 410 may include one or more processing units. The processor 410 may be integrated with an application processor and a modem processor. The application processor mainly processes the operating system, the user interface, applications, and the like. The modem processor mainly processes wireless communication. It may be understood that, alternatively, the modem processor may not be integrated into the processor 410.

The terminal 400 may further include the power supply 411 (such as a battery) that supplies power to each component. The power supply 411 may be logically connected to the processor 410 by using a power management system, so as to implement functions such as charging, discharging, and power consumption management by using the power management system.

In addition, the terminal 400 includes some function modules that are not shown. Details are not described herein again.

An embodiment of the present disclosure further provides a terminal, including a processor 410, a memory 409, and a computer program stored in the memory 409 and executable on the processor 410. When executed by the processor 410, the computer program implements the foregoing processes of the method embodiment of entering a dormancy behavior, and a same technical effect can be achieved. To avoid repetition, details are not described herein again.

An embodiment of the present disclosure further provides a computer-readable storage medium. A computer program is stored in the computer-readable storage medium. When being executed by a processor, the method of entering a dormancy behavior provided in the embodiments of the present disclosure can be implemented, and a same technical effect can be achieved. To avoid repetition, details are not described herein again. The computer-readable storage medium may be a read-only memory (ROM), a random access memory (RAM), a magnetic disk, a compact disc, or the like.

It should be noted that in this specification, the terms “comprise”, “include” and any other variants thereof are intended to cover non-exclusive inclusion, so that a process, a method, an article, or an apparatus that includes a series of elements not only includes these very elements, but may also include other elements not expressly listed, or also include elements inherent to this process, method, article, or apparatus. An element limited by “includes a . . . ” does not, without more constraints, preclude the presence of additional identical elements in the process, method, article, or apparatus that includes the element.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation. Based on such understanding, the technical solutions of the present disclosure essentially or the part contributing to the related art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of the present disclosure.

The embodiments of the present disclosure are described above with reference to the accompanying drawings, but the present disclosure is not limited to the foregoing specific implementations. The foregoing specific implementations are merely exemplary instead of restrictive. Under enlightenment of the present disclosure, a person of ordinary skill in the art may make many forms without departing from the aims of the present disclosure and the protection scope of claims, all of which fall within the protection scope of the present disclosure.

1. A method for entering a dormancy behavior, performed by a terminal, comprising:
receiving indication information indicating that the terminal enters the dormancy behavior; and
in a case that conditions of validity are satisfied, entering, by the terminal, the dormancy behavior based on the indication information,
wherein the conditions of validity comprise at least one of the following:
scheduled data is successfully transmitted;
a quantity of times of transmission of the scheduled data reaches a maximum quantity of times of retransmission; or
a first timer expires.

2. The method according to claim 1, in a case that the scheduled data is downlink data, the scheduled data is successfully transmitted when the terminal successfully receives the scheduled data, or a sent Hybrid Automatic Repeat Request (HARQ) feedback corresponding to the scheduled data is an acknowledgement (ACK); or
in a case the scheduled data is uplink data, the scheduled data is successfully transmitted when the terminal does not receive an indication of rescheduling the scheduled data.

3. The method according to claim 1, in a case that the scheduled data is downlink data, the first timer is started in a case that a Hybrid Automatic Repeat Request (HARQ) feedback sent by the terminal and corresponding to the scheduled data is a Negative-Acknowledgment (NACK), or if the scheduled data is uplink data, the first timer is started in a case that the terminal has sent the scheduled data.

4. The method according to claim 1, in a case that the terminal is configured with a first timer, the conditions of validity comprise:
before the first timer expires, the scheduled data is transmitted successfully.

5. The method according to claim 1, in a case that the terminal is configured with the maximum quantity of times of retransmission, the conditions of validity comprise:
when the quantity of times of transmission of the scheduled data is less than or equal to the maximum quantity of times of retransmission, the scheduled data is transmitted successfully.

6. The method according to claim 1, in a case that the terminal is configured with a first timer and the maximum quantity of times of retransmission, the conditions of validity comprise:
the quantity of times of transmission of the scheduled data is less than or equal to the maximum quantity of times of retransmission, and before the first timer expires, the scheduled data is transmitted successfully.

7. The method according to claim 1, wherein the first timer is a discontinuous reception (DRX) retransmission timer, or the first timer is a dormancy-retransmission timer.

8. The method according to claim 7, wherein the terminal is configured with a second timer;
in a case that the scheduled data is downlink data, the first timer is started when a Hybrid Automatic Repeat Request (HARQ) feedback sent by the terminal and corresponding to the scheduled data is a Negative-Acknowledgment (NACK), and the second timer expires, wherein the second timer is started in a case that the terminal has sent the HARQ feedback; or
in a case that the scheduled data is uplink data, the first timer is started in a case that the second timer expires, wherein the second timer is started in a case that the terminal has sent the scheduled data.

9. The method according to claim 8, wherein the second timer is a DRX HARQ timer, or the second timer is a dormancy HARQ timer.

10. The method according to claim 9, wherein the terminal ignores to monitor a Physical Downlink Control Channel (PDCCH) before the second timer expires.

11. The method according to claim 8, wherein the terminal is configured with the first timer and the second timer for each HARQ process respectively.

12. The method according to claim 1, wherein the receiving the indication information indicating that the terminal enters the dormancy behavior comprise:
receiving a first Physical Downlink Control Channel (PDCCH) or a Media Access Control Control Element (MAC CE) indicating that the terminal enters the dormancy behavior.

13. The method according to claim 12, wherein the scheduled data is data scheduled by the first PDCCH, or the scheduled data is data scheduled by a second PDCCH, wherein a reception time of the second PDCCH is before a reception time of the first PDCCH.

14. The method according to claim 1, in a case that the terminal enters the dormancy behavior, the terminal ignores to monitor a Physical Downlink Control Channel (PDCCH), or the terminal monitors the PDCCH in a first period, wherein the first period is greater than a second period, and the second period is a monitoring period for monitoring the PDCCH when the terminal does not enter the dormancy behavior.

15. A terminal, comprising a memory storing a program and a processor, wherein when the program is executed by the processor, it implements a method for entering a dormancy behavior, comprising:
receiving indication information indicating that the terminal enters the dormancy behavior; and
in a case that conditions of validity are satisfied, entering, by the terminal, the dormancy behavior based on the indication information,
wherein the conditions of validity comprise at least one of the following:
scheduled data is successfully transmitted;
a quantity of times of transmission of the scheduled data reaches a maximum quantity of times of retransmission; or
a first timer expires.

16. The terminal according to claim 15, in a case that the scheduled data is downlink data, the scheduled data is successfully transmitted when the terminal successfully receives the scheduled data, or a sent Hybrid Automatic Repeat Request (HARQ) feedback corresponding to the scheduled data is an acknowledgement (ACK); or
in a case the scheduled data is uplink data, the scheduled data is successfully transmitted when the terminal does not receive an indication of rescheduling the scheduled data.

17. The terminal according to claim 15, in a case that the scheduled data is downlink data, the first timer is started in a case that a Hybrid Automatic Repeat Request (HARQ) feedback sent by the terminal and corresponding to the scheduled data is a Negative-Acknowledgment (NACK), or if the scheduled data is uplink data, the first timer is started in a case that the terminal has sent the scheduled data.

18. The terminal according to claim 15, wherein the first timer is a discontinuous reception (DRX) retransmission timer, or the first timer is a dormancy-retransmission timer.

19. The terminal according to claim 15, wherein the receiving the indication information indicating that the terminal enters the dormancy behavior comprise:
receiving a first Physical Downlink Control Channel (PDCCH) or a Media Access Control Control Element (MAC CE) indicating that the terminal enters the dormancy behavior.

20. Anon-transitory computer-readable storage medium storing a computer program, when executed by a processor, implements a method for entering a dormancy behavior, comprising:
receiving indication information indicating that the terminal enters the dormancy behavior; and
in a case that conditions of validity are satisfied, entering, by the terminal, the dormancy behavior based on the indication information,
wherein the conditions of validity comprise at least one of the following:
scheduled data is successfully transmitted;
a quantity of times of transmission of the scheduled data reaches a maximum quantity of times of retransmission; or
a first timer expires.
